(19) United States
(12) Patent Application Publication
(10) Pub. No.: US 2012/0146781 A1
(43) Pub. Date: Jun. 14, 2012

(54) COLLISION AVOIDANCE

(75) Inventors: Stephen Darryll Thomas, Delaware, OH (US); Timothy John Reilly, Kelowna (CA); James Conroy Moore, Columbus, OH (US)

(73) Assignee: Wirefree Corporation, Powell, OH (US)

(21) Appl. No.: 13/396,943

(22) Filed: Feb. 15, 2012

Related U.S. Application Data
(63) Continuation of application No. 12/728,186, filed on Mar. 19, 2010.

(51) Int. Cl. G08B 7/06

(52) U.S. Cl. 340/435

(57) ABSTRACT

A system for warning of potential collisions among subjects includes devices configured to be transported by the subjects. At least one of the devices may have a device identifier and may include a transceiver configured to transmit radio frequency signals including the device identifier. At least one of the devices may include a processor operably connected to a transceiver configured to receive radio frequency signals. In at least one of the devices, the processor is configured to store another device's identifier in a storage medium, to determine a signal strength of a radio frequency signal received from the other device, and to issue a warning signal based at least in part on at least one of the signal strength and the other device's identifier. The warning signal is configured to warn a subject of a potential collision with another subject.

### BACKGROUND

Certain workplaces may have a relatively higher likelihood of collisions between work vehicles and people or between vehicles. For example, vehicle operators transporting loads in a warehouse may not always see or hear others working in proximity.

Collision avoidance systems such as traffic lights and mirrors may be installed only in limited areas such as intersections, leaving substantial areas unprotected.

### BRIEF DESCRIPTION OF THE DRAWINGS

The accompanying drawings, which are incorporated in and constitute a part of the specification, illustrate various example systems, methods, and so on, that illustrate various example embodiments of aspects of the invention. It will be appreciated that the illustrated element boundaries (e.g., boxes, groups of boxes, or other shapes) in the figures represent one example of the boundaries.

One of ordinary skill in the art will appreciate that one element may be designed as multiple elements or that multiple elements may be designed as one element. An element shown as an internal component of another element may be implemented as an external component and vice versa. Furthermore, elements may not be drawn to scale.

FIG. 1 illustrates an example system for warning of potential collisions among a plurality of subjects.

FIG. 2 illustrates a block diagram of an example system for warning of potential collisions among a plurality of subjects.

FIG. 3 illustrates an example device or apparatus configured to warn of potential collisions.

FIG. 4 illustrates a top view of a vehicle in an example system for warning of potential collisions.

FIG. 5 illustrates an alternative embodiment of an apparatus for warning of a potential collision

FIG. 6 illustrates a flow diagram for an example method for avoiding collisions.

### DETAILED DESCRIPTION

The following includes definitions of selected terms employed herein. The definitions include various examples, forms, or both of components that fall within the scope of a term and that may be used for implementation. The examples are not intended to be limiting. Both singular and plural forms of terms may be within the definitions.

“Computer-readable medium,” as used herein, refers to a medium that participates in directly or indirectly providing signals, instructions or data. A computer-readable medium may take forms, including, but not limited to, non-volatile media, volatile media, and transmission media. Non-volatile media may include, for example, optical or magnetic disks, and so on. Volatile media may include, for example, optical or magnetic disks, dynamic memory and the like. Transmission media may include coaxial cables, copper wire, fiber optic cables, and the like. Transmission media can also take the form of electromagnetic radiation, like that generated during radio-wave and infra-red data communications, or take the form of one or more groups of signals. Common forms of a computer-readable medium include, but are not limited to, a floppy disk, a flexible disk, a hard disk, a magnetic tape, other magnetic media, a CD-ROM, other optical media, punch cards, paper tape, other physical media with patterns of holes, a RAM, a ROM, an EPROM, a FLASH-EPROM, or other memory chip or card, a memory stick, a carrier wave/pulse, and other media from which a computer, a processor or other electronic device can read. Signals used to propagate instructions or other software over a network, like the Internet, can be considered a “computer-readable medium.”

“Storage Medium,” as used herein, refers to a physical or logical entity that can store data. A storage medium may be, for example, a database, a table, a file, a list, a queue, a heap, a memory, a register, and so on. A storage medium may reside in one logical or physical entity or may be distributed between two or more logical or physical entities.

“Logic,” as used herein, includes but is not limited to hardware, firmware, software or combinations of each to perform a function(s) or an action(s), or to cause a function or action from another logic, method, or system. For example, based on a desired application or needs, logic may include a software controlled microprocessor, discrete logic like an application specific integrated circuit (ASIC), a programmed logic device, a memory device containing instructions, or the like. Logic may include one or more gates, combinations of gates, or other circuit components. Logic may also be fully embodied as software. Where multiple logical logics are described, it may be possible to incorporate the multiple logical logics into one physical logic. Similarly, where a single logical logic is described, it may be possible to distribute that single logical logic between multiple physical logics.

An “operable connection,” or a connection by which entities are “operably connected,” is one in which signals, physical communications, or logical communications may be sent or received. Typically, an operable connection includes a physical interface, an electrical interface, or a data interface, but it is to be noted that an operable connection may include differing combinations of these or other types of connections sufficient to allow operable control. For example, two entities can be operably connected by being able to communicate signals to each other directly or through one or more intermediate entities like a processor, operating system, a logic, software, or other entity. Logical or physical communication channels can be used to create an operable connection.

“Query,” as used herein, refers to a semantic construction that facilitates gathering and processing information. A query might be formulated in a database query language like structured query language (SQL) or object query language (OQL). A query might be implemented in computer code (e.g., C#, C++, Javascript) that can be employed to gather information from various data stores or information sources.

“Signal,” as used herein, includes but is not limited to one or more electrical or optical signals, analog or digital signals, data, one or more computer or processor instructions, messages, a bit or bit stream, or other means that can be received, transmitted or detected.

“Software,” as used herein, includes but is not limited to, one or more computer or processor instructions that can be read, interpreted, compiled, or executed and that cause a computer, processor, or other electronic device to perform functions, actions or behave in a desired manner. The instructions may be embodied in various forms like routines, algorithms, modules, methods, threads, or programs including separate applications or code from dynamically or statically linked libraries. Software may also be implemented in a variety of executable or loadable forms including, but not limited to, a stand-alone program, a function call (local or remote), a servelet, an applet, instructions stored in a memory, part of an operating system or other types of executable instructions. It will be appreciated by one of ordinary skill in the art that the form of software may depend, for example, on requirements of a desired application, the environment in which it runs, or the desires of a designer/programmer or the like. It will also be appreciated that computer-readable or executable instructions can be located in one logic or distributed between two or more communicating, co-operating, or parallel processing logics and thus can be loaded or executed in serial, parallel, massively parallel and other manners.

Suitable software for implementing various components of the example systems and methods described herein may be produced using programming languages and tools like Java, Pascal, C#, C++, C, CGI, Perl, SQL, APIs, SDKs, assembly, firmware, microcode, or other languages and tools. Software, whether an entire system or a component of a system, may be embodied as an article of manufacture and maintained or provided as part of a computer-readable medium as defined previously. Another form of the software may include signals that transmit program code of the software to a recipient over a network or other communication medium. Thus, in one example, a computer-readable medium has a form of signals that represent the software/firmware as it is downloaded from a web server to a user. In another example, the computer-readable medium has a form of the software/firmware as it is maintained on the web server. Other forms may also be used.

“User,” as used herein, includes but is not limited to one or more persons, software, computers or other devices, or combinations of these.

Some portions of the detailed descriptions that follow are presented in terms of algorithms and symbolic representations of operations on data bits within a memory. These algorithmic descriptions and representations are the means used by those skilled in the art to convey the substance of their work to others. An algorithm is here, and generally, conceived to be a sequence of operations that produce a result. The operations may include physical manipulations of physical quantities. Usually, though not necessarily, the physical quantities take the form of electrical or magnetic signals capable of being stored, transferred, combined, compared, and otherwise manipulated in a logic and the like.

It has proven convenient at times, principally for reasons of common usage, to refer to these signals as bits, values, elements, symbols, characters, terms, numbers, or the like. It should be borne in mind, however, that these and similar terms are to be associated with the appropriate physical quantities and are merely convenient labels applied to these quantities. Unless specifically stated otherwise, it is appreciated that throughout the description, terms like processing, computing, calculating, determining, displaying, or the like, refer to actions and processes of a computer system, logic, processor, or similar electronic device that manipulates and transforms data represented as physical (electronic) quantities.

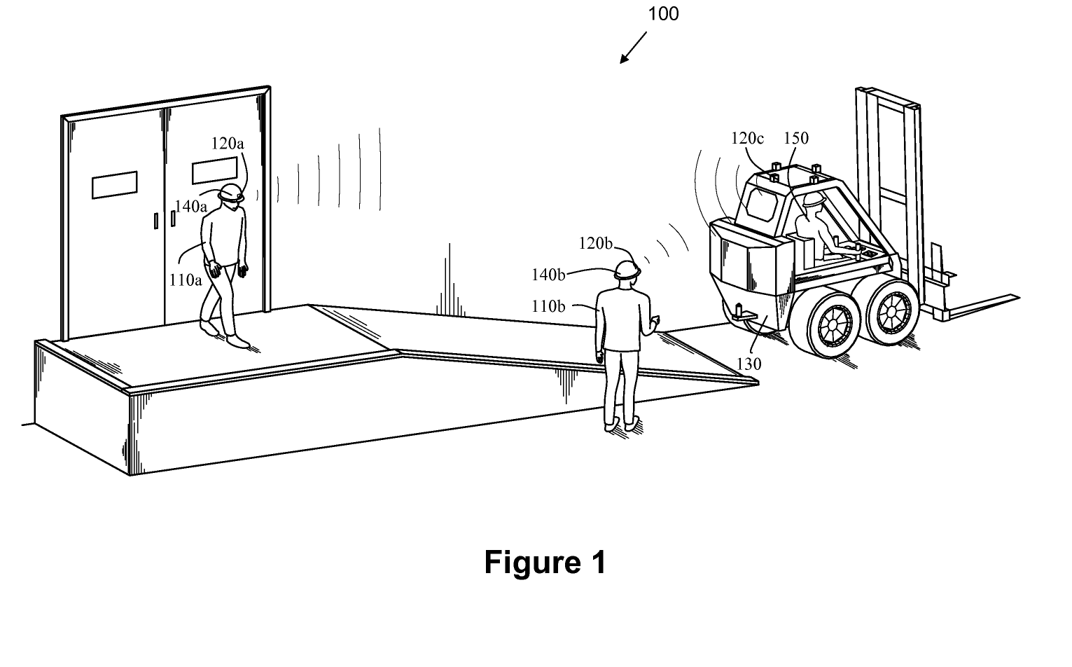

FIG. 1 illustrates a system 100 for warning of potential collisions among a plurality of subjects. The system 100 may include a plurality of devices or apparatuses. Subjects may include persons, vehicles, containers, cranes, and so on. In the illustrated embodiment a first person 110a carries or transports a first device 120a, a second person 110b carries a second device 120b and a vehicle 130 carries a third device 120c.

The first device 120a and the second device 120b may be configured to operably attach to a hat (e.g. hardhat, and so on). In the illustrated embodiment, the first person 110a is wearing a first hardhat 140a which has the first device 120a attached. In the illustrated embodiment, the second person 110b is wearing a second hardhat 140b which has the second device 120b attached. In other embodiments, the first device 120a or the second device 120b may be configured to be carried in a way other than attached to a hat. For example, the first device 120a and the second device 120b may be configured to be attached to a belt, pocket, and so on.

In the system 100, each of the devices 120a-c detects the presence of the others devices in the area. Each of the devices 120a-c also determines the types of devices in the area and whether to issue warning signals based on the proximity and the type of device in proximity. For example, in the illustrated embodiment, the first device 120a detects the presence of the second device 120b and the third device 120c. The first device 120a determines that the second device 120b is a device of a type carried by a person 110b.

In one embodiment, if a person type device detects proximity to another person type device, the person type devices do not issue warning signals. For example, the first device 120a may determine that the second 120b is at a close distance to the first device 120a; the first person 110a may be close to the second person 110b. However, since the second device 120b was detected as a type corresponding to a person, a warning signal is not issued. In other embodiments warning signals may be issued even when the devices in proximity correspond to devices of a type carried by persons.

The first device 120a may also determine that the third device 120c is a device of a type carried by a vehicle 130. The first device 120a may determine that the third device 120c is at a safe distance to the first device 120a (the first person 110a is not too close to the vehicle 130) and not issue a warning signal.

Similarly, the second device 120b detects the presence of the first device 120a and the third device 120c. The second device 120b determines that the first device 120a is a device of a type carried by a person 110a. The second device 120b determines that the third device 120c is a device carried by a vehicle 130. The second device 120b may determine that the third device 120c is at too close a distance to the second device 120b; the second person 110b may be too close to the vehicle 130 and the two may collide. Therefore, the second device 120b may issue a warning signal to notify the second person 110b. In one embodiment, the warning signal takes the form of a warning light (e.g. LED) that is attached to the brim of the hardhat. In other embodiments, the warning signal may take the form of flashing lights, sounds, vibrations, and so on.

The second device 120b may determine that the first device 120a is at a close distance to the second device 120b; the second person 110b may be close to the first person 110a. However, since the first device 120a was detected as a type corresponding to a person, a warning signal may not be issued.

In the illustrated embodiment, the third device 120c detects the presence of the first device 120a and the second device 120b. The third device 120c determines that both the first device 120a and the second device 120b correspond to devices carried by people 110a-b. The third device 120c further determines that the first device 120a is at a safe distance from the third device 120c. The third device 120c, however, may determine that the second device 120b is at too close a distance to the third device 120c; the second person 110b may be too close to the vehicle 130 and the two may collide. Therefore, the third device 120c may issue a warning signal to notify an operator 150 of the vehicle 130.

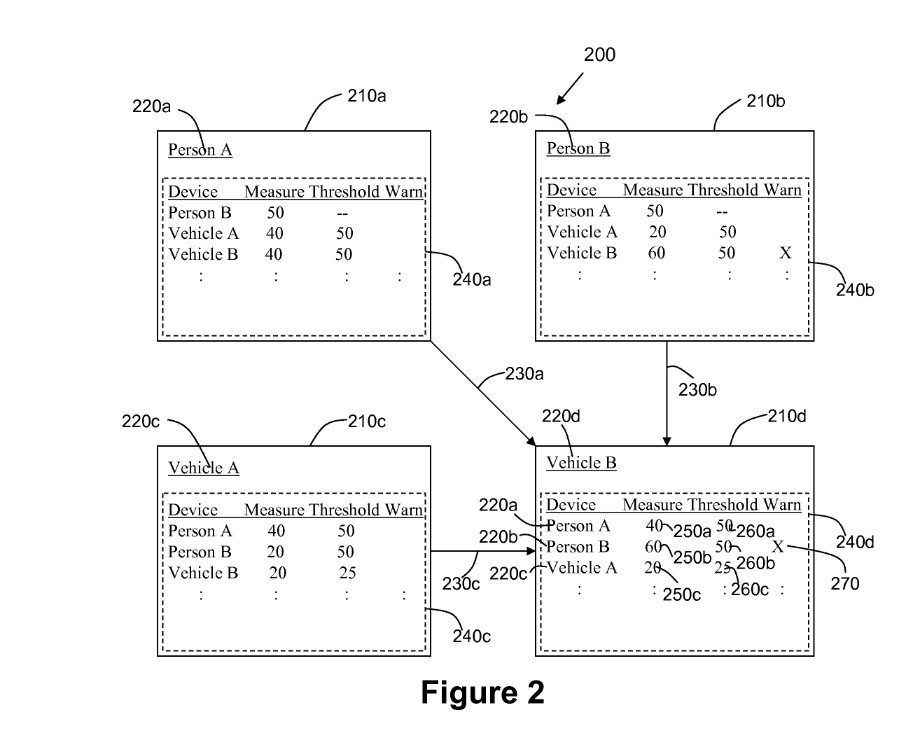

FIG. 2 illustrates a block diagram of a system 200 for warning of potential collisions among a plurality of subjects. In the illustrated embodiment, the system 200 includes four devices 210a, 210b, 210c, and 210d. At least in theory, the amount of devices in the system 200 may be infinite.

In the illustrated embodiment, the first device 210a has a first device identifier 220a which may uniquely identify the first device 210a in the system, or the first device identifier 220a may identify the type of device of the first device 210a, or both. For example, the first device identifier 220a identifies the first device as Person A, which indicates that the first device 210a corresponds to a person. The second device 210b has a second device identifier 220b. The second device identifier 220b identifies the second device as Person B, which indicates that the second device 210b also corresponds to a person, but that the second device 210b is a device different than the first device 210a.

In the illustrated embodiment, the third device 210c has a third device identifier 220c which may uniquely identify the third device 210c in the system, or the third device identifier 220c may identify the type of device of the third device 210c, or both. For example, the third device identifier 220c identifies the third device as Vehicle A, which indicates that the third device 210c corresponds to a vehicle. The fourth device 210d has a fourth device identifier 220d. The fourth device identifier 220d identifies the fourth device as Vehicle B, which indicates that the fourth device 210d also corresponds to a vehicle, but that the fourth device 210d is a different device than the third device 210c.

All four devices 210a, 210b, 210c, and 210d may transmit radio frequency (RF) signals including their respective device identifiers. In the illustrated embodiment, the first device 210a, the second device 210b, and the third device 210c transmit a first RF signal 230a, a second RF signal 230b, and a third RF signal 230c respectively. The first RF signal 230a includes the first device identifier 220a. The second RF signal 230b includes the second device identifier 220b. The third RF signal 230c includes the third device identifier 220c. In one embodiment, the devices 210a, 210b, 210c, and 210d are configured to transmit their respective RF signals several times per second. In one embodiment, the devices 210a, 210b, 210c, and 210d are configured to transmit their respective RF signals approximately four times per second. In one embodiment, the devices 210a, 210b, 210c, and 210d are configured to transmit their respective RF signals approximately five times per second. In other embodiments, the devices 210a, 210b, 210c, and 210d are configured to transmit their respective RF signals less frequently than five times per second or more frequently than four times per second.

All four devices 210a, 210b, 210c, and 210d may receive RF signals from other devices in the system. In the illustrated embodiment, the fourth device 210d receives the first RF signal 230a, the second RF signal 230b, and the third RF signal 230c.

All four devices 210a, 210b, 210c, and 210d may also include tables or databases 240a, 240b, 240c, and 240d respectively. The devices 210a, 210b, 210c, and 210d may store system data in their corresponding table or database 240a, 240b, 240c, and 240d. The system data stored in databases 240a, 240b, 240c, and 240d may include measurements of signal strengths, approximate physical distances, warning thresholds, and so on corresponding to other devices in the system.

For example, the fourth device 210d stores in database 240d values corresponding to measurements 250a, 250b, and 250c of signal strength or approximate distance of other devices. In the illustrated embodiment, the first measurement 250a, the second measurement 250b, and the third measurement 250c represent values of the measured signal strength of the respective signal. In other embodiments, the first measurement 250a, the second measurement 250b, and the third measurement 250c may represent approximated distances from the fourth device 210d to the respective other devices calculated based on the measured signal strength.

All four devices 210a, 210b, 210c, and 210d may also store in their corresponding table or database 240a, 240b, 240c, and 240d values corresponding to warning thresholds 260a, 260b, and 260c corresponding to signal strengths or approximate distances of other devices beyond which to issue warning signals. In the illustrated embodiment, the fourth device 210d stores the first threshold 260a, the second threshold 260b, and the third threshold 260c. The thresholds 260a, 260b, and 260c represent values of the measured signal strength of the respective signal beyond which the fourth device 210d would issue warning signals. In other embodiments, the thresholds 260a, 260b, and 260c may represent threshold distances from the fourth device 210d to the respective device beyond which the fourth device 210d would issue warning signals.

In the illustrated embodiment, the fourth device identifier 220d identifies the fourth device 210d as a Vehicle B. The fourth device 210d receives the first signal 230a from the first device 210a. The fourth device 210d obtains from the first signal 230a the first device identifier 220a identifying the first device 210a as a Person A. The fourth device 210d stores the first device identifier 220a in the fourth table 240d. The fourth device 210d also stores in the fourth table 240d a Vehicle B-Person A threshold 260a corresponding to a signal strength of the first signal 230a beyond which the fourth device would issue a warning signal.

In the illustrated embodiment, the fourth device 210d measures the strength of the first signal 230a. The fourth device 210d may then store the measurement as Vehicle B-Person A measurement 250a in the fourth table 240d. In other embodiments, the fourth device 210d may not store the Vehicle B-Person A measurement 250a in the fourth table 240d. The fourth device 210d compares the Vehicle B-Person A measurement 250a to the Vehicle B-Person A threshold 260a and issues a warning signal based on the comparison. In the illustrated embodiment, the Vehicle B-Person A measurement 250a is 40 while the Vehicle B-Person A threshold 260a is 50. Since the Vehicle B-Person A measurement 250a is lower than the Vehicle B-Person A threshold 260a, the fourth device 210d does not issue a warning signal.

In the illustrated embodiment, the fourth device 210d receives the second signal 230b from the second device 210b. The fourth device 210d obtains from the second signal 230b the second device identifier 220b identifying the second device 210b as a Person B. The fourth device 210d stores the second device identifier 220b in the fourth table 240d. The fourth device 210d also stores in the fourth table 240d a Vehicle B-Person B threshold 260b. The fourth device 210d measures the strength of the second signal 230b and compares the Vehicle B-Person B measurement 250b to the Vehicle B-Person B threshold 260b. In the illustrated embodiment, the Vehicle B-Person B measurement 250b is 60 while the Vehicle B-Person B threshold 260b is 50. Since the Vehicle B-Person B measurement 250b is higher than the Vehicle B-Person B threshold 260b, the fourth device 210d issues a warning signal 270.

In one embodiment, the system 200 uses hysteresis when determining whether to issue or stop issuing a warning signal. For example, the fourth device 210d measures the strength of the second signal 230b and compares the Vehicle B-Person B measurement 250b to the Vehicle B-Person B threshold 260b. In the illustrated embodiment, the Vehicle B-Person B measurement 250b is 60 while the Vehicle B-Person B threshold 260b is 50. Since the Vehicle B-Person B measurement 250b is higher than the Vehicle B-Person B threshold 260b, the fourth device 210d issues a warning signal 270.

However, as the person, Person B, carrying the second device 210b walks away from the vehicle, Vehicle B, carrying the fourth device 210d, the Vehicle B-Person B measurement 250b lowers. The Vehicle B-Person B measurement 250b may come down to, for example, 49. Although, the Vehicle B-Person B measurement 250b is now lower than the Vehicle B-Person B threshold 260b of 50, the fourth device 210d may not stop issuing the warning signal 270 until the Vehicle B-Person B measurement 250b becomes significantly lower than the Vehicle B-Person B threshold 260b. Person B may have to walk farther away from Vehicle B before the warning signal 270 clears.

In one embodiment, the device identifiers 220a-d each correlates to a set of preprogrammed threshold between the identified devices and other devices in the system 200. For example, in the illustrated embodiment the first device identifier 220a indicates to the fourth device 210d that the first device 210a is a person. The fourth device 210d being a vehicle type device may have a preprogrammed threshold corresponding to interactions with persons. The threshold 260a may be a preprogrammed threshold of 50 between vehicles and persons.

In one embodiment, devices 210a-d may belong to a group (not shown). The devices 210a-d may make decisions regarding other devices based on the group or groups to which the other devices belong. For example, the first device 210a may belong to a first group, Group 1, while the second device 220a may belong to a second group, Group 2. The first device 210a may not issue a warning signal even when within threshold proximity to the second device 210b based on the second device 210 belonging to a different group or based on the second device 210 belonging to Group 2. Alternatively, the first device 210a may issue a warning signal when within threshold proximity to the second device 210b based on the second device 210 belonging to a different group or based on the second device 210 belonging to Group 2.

In another example, the first device 210a and the second device 220a may belong to the same group, Group 1. The first device 210a may not issue a warning signal even when within threshold proximity to the second device 210b based on the second device 210 belonging to the same group as device 210a. Alternatively, the first device 210a may issue a warning signal when within threshold proximity to the second device 210b based on the second device 210 belonging to the same group.

Decisions other than whether to issue warning signals may also be based on group membership. For example, the devices 210a-d may issue different types of warning signals based on group membership. In that example, the first device 210a may flash a light in response to proximity to devices belonging to Group 2, while the first device 210a may vibrate in response to proximity to devices belonging to a Group 3.

Groups may be based on device type (e.g. person, vehicle, and so on). Groups may also be programmed into the device and based on criteria other than device type.

All four devices 210a, 210b, 210c, and 210d may also store in their corresponding table or database 240a, 240b, 240c, and 240d historical data (not shown). The historical data may be used for analysis and record keeping. For example, in case of a collision, the historical data may be used forensically to determine the status of the various signals and settings of the system 200 at the time of the collision.

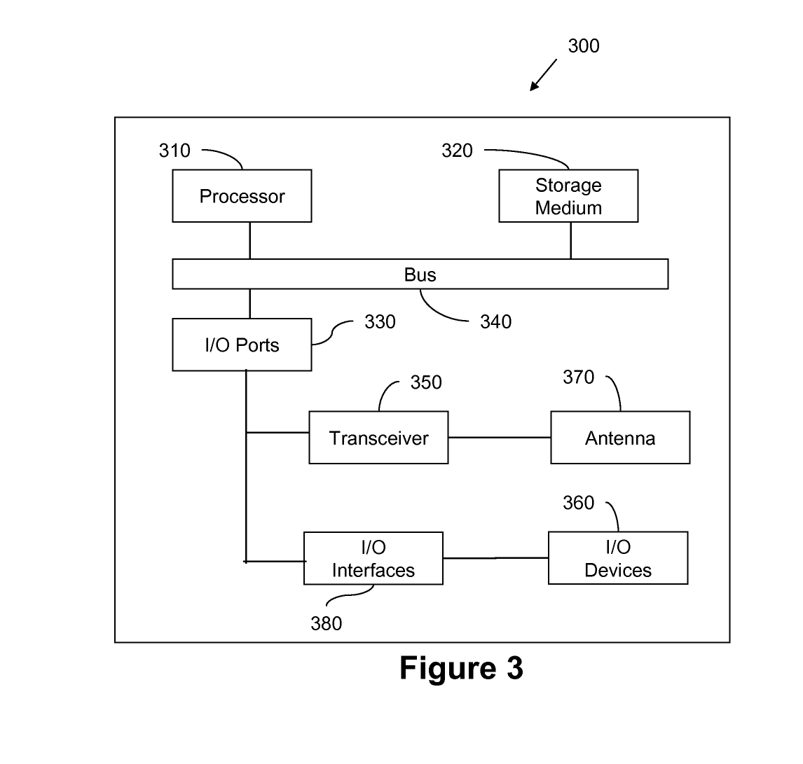

FIG. 3 illustrates a device or apparatus 300 configured to warn of potential collisions. The apparatus 300 may include a processor 310, a storage medium 320, and I/O Ports 330 operably connected by a bus 340.

The processor 310 can be selected from a variety of processors including dual microprocessor and other multi-processor architectures. The storage medium 320 can include volatile memory or non-volatile memory. Non-volatile memory can include, but is not limited to, ROM, PROM, EPROM, EEPROM, and so on. Volatile memory can include, for example, RAM, synchronous RAM (SRAM), dynamic RAM (DRAM), synchronous DRAM (SDRAM), double data rate SDRAM (DDR SDRAM), and direct RAM bus RAM (DRRAM). The storage medium 320 can also include magnetic disk drives, solid state disk drives, flash memory, and so on. The storage medium 320 can store processes or data. The storage medium 320 can also store an operating system that may control or allocate resources of the apparatus 300.

The bus 340 can be a single internal bus interconnect architecture or other bus or mesh architectures. While a single bus is illustrated, it is to be appreciated that apparatus 300 may communicate with various devices, logics, and peripherals using other busses that are not illustrated (e.g., PCIE, SATA, Infiniband, 1394, USB, Ethernet). The bus 340 can be of a variety of types including, but not limited to, a memory bus or memory controller, a peripheral bus or external bus, a crossbar switch, or a local bus. The local bus can be of varieties including, but not limited to, an industrial standard architecture (ISA) bus, a microchannel architecture (MCA) bus, an extended ISA (EISA) bus, a peripheral component interconnect (PCI) bus, a universal serial (USB) bus, and a small computer systems interface (SCSI) bus.

The apparatus 300 may further include a transceiver 350 operably connected to the processor 310. The transceiver 350 may be configured to transmit RF signals and to receive RF signals from other devices. In one embodiment, the apparatus 300 employs a Texas Instrument CC2530 system-on-chip solution operating in the 2.4 GHz frequency band. In one embodiment, the transceiver 350 is configured to receive RF signals that include device identifiers. The processor 310 may be configured to store the device identifiers in the storage medium 320. The processor 310 may be configured to also store warning thresholds in the storage medium 320. The processor 310 may further be configured to determine signal strengths of the received RF signals.

In one embodiment, the processor 310 determines the signal strengths based on sampling of a received signal strength indicator (RSSI). In one embodiment, the processor 310 is configured to determine the signal strengths by continuously sampling the RSSI of the received signal and calculating a running average of the obtained samples while eliminating outlier samples. The processor 310 may also be configured to compare the determined signal strengths with the warning thresholds and issue warning signals via one or more input/output devices 360.

The apparatus 300 may further include at least one antenna 370 operably connected to the transceiver 350. In one embodiment, the antenna 370 has a set of power settings that are programmable to control characteristics of the antenna 370 including the gain among other characteristics. In one embodiment, the apparatus 300 may have a radio profile including various settings including radio broadcast power, transmission signal strength and the antenna characteristics. In one embodiment, the radio profile may be included in the RF signal transmitted. The processor 310 may be configured to store the radio profile included in a received RF signal in the storage medium 320. The processor 310 may further be configured to determine signal strengths or issue warning signals based at least in part on some or all of the various settings included in the radio profile. In one embodiment, the radio profile is preprogrammed such that the transceiver 350 effectively transmits the RF signal approximately 300 feet. In other embodiments, the radio profile may be preprogrammed such that the transceiver 350 effectively transmits the RF signal distances of less than 300 feet or distances of more than 300 feet.

The apparatus 300 may interact with the transceiver 350 and the other input/output devices 360 via I/O Interfaces 380 or I/O Ports 330. Input/output devices 360 can include, but are not limited to, a light, a flashing light, a vibrator, a speaker, a piezoelectric device, a keyboard, a pointing and selection device, cameras, video cards, displays, network devices, and so on. The I/O Ports 330 can include but are not limited to, serial ports, parallel ports, and USB ports.

The apparatus 300 can operate in a network environment and thus may be connected to other devices via the transceiver 350, the I/O Interfaces 380, or the I/O Ports 330. Through the network, the apparatus 300 may be logically connected to other devices similar to the apparatus 300 or to remote computers. The networks with which the apparatus 300 may interact include, but are not limited to, a local area network (LAN), a wide area network (WAN), and other networks. LAN may include fiber distributed data interface (FDDI), copper distributed data interface (CDDI), Ethernet (IEEE 802.3), token ring (IEEE 802.5), Wi-Fi (IEEE 802.11), Bluetooth (IEEE 802.15.1), Zigbee (IEEE 802.15.4) and the like. WAN may include point to point links, circuit switching networks like integrated services digital networks (ISDN), packet switching networks, and digital subscriber lines (DSL). While individual network types are described, it is to be appreciated that communications via, over, or through a network may include combinations and mixtures of communications.

In one embodiment, the apparatus 300 may be queried or programmed via the I/O Interfaces 380. Settings that may be programmed via the I/O Interfaces 380 include the thresholds, the radio profile, the device types, and so on. Data that may be queried via the I/O Interfaces 380 include the historical data that may be stored in the storage medium 320. In one embodiment, the I/O Interfaces 380 include a wireless link between a wireless device and the apparatus 300. In this embodiment, the apparatus 300 may be queried or programmed via the wireless link. In one embodiment, the wireless link is an IEEE 802.11 (Wi-Fi) link. In another embodiment, the wireless link may be an IEEE 802.15.1 (Bluetooth) link.

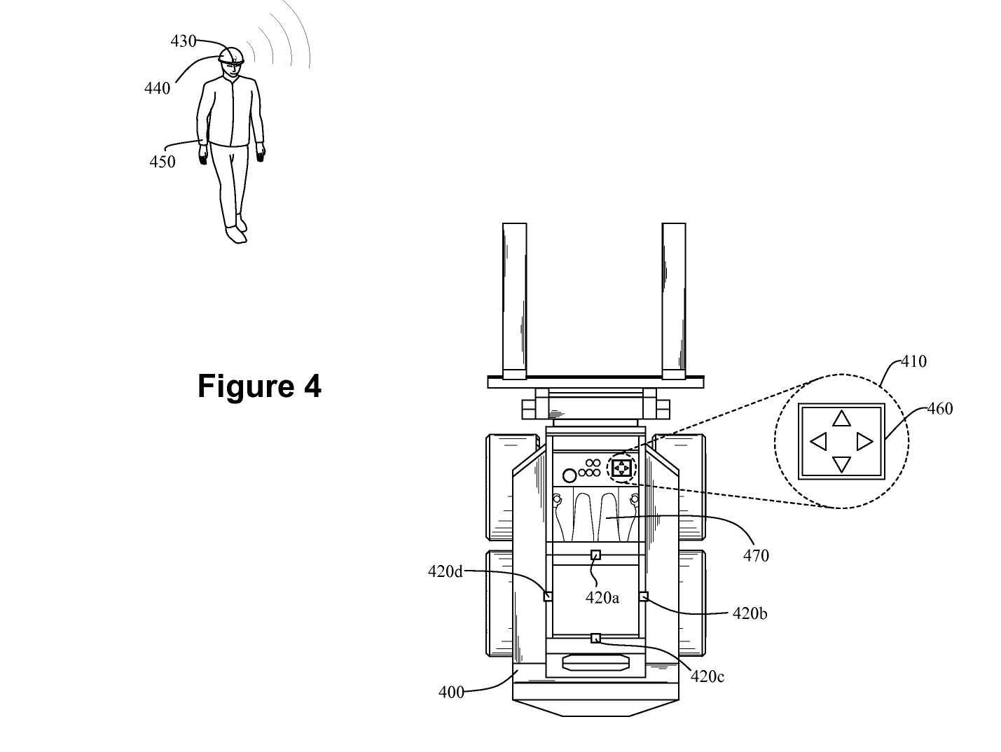

FIG. 4 illustrates a top view of a vehicle 400. In the illustrated embodiment, the vehicle 400 is equipped with an apparatus 410 for warning of potential collisions. The transceiver (not shown) of apparatus 410 may be operably connected to four antennas 420a-d. The antennas 420a-d are operably attached or connected to the vehicle 400. In the embodiment, the measured signal strength of an incoming RF signal may have four components, one for each of the four antennas 420a-d. The incoming direction of the RF signal may be determined based on the signal strength measured at each of the four antennas 420a-d relative to the other three antennas.

For example, the RF signal transmitted by the device 430 on the hardhat 440 worn by the person 450 is received by the four antennas 420a-d. However, since antennas 420a and 420d are physically closer to the device 430 than the antennas 420b and 420c, the signal strength of the RF signal measured at antennas 420a and 420d would likely be stronger than the signal strength of the RF signal measured at antennas 420b and 420c. The apparatus 410 may determine the direction from which the RF signal is being transmitted based on the relatively difference between the four signal strength components. Therefore, the apparatus 410 equipped with the four antennas 420a-d may determine from what direction is the person 450 approaching the vehicle 400. In other embodiments, the transceiver of the apparatus 410 may be operably connected to two or three antennas to determine the direction of the incoming signal. In other embodiments, the transceiver of the apparatus 410 may be operably connected to more than four antennas to determine the direction of the incoming signal.

In the illustrated embodiment, the apparatus 410 is equipped with a display 460. The display may use arrows to indicate to a vehicle operator 470 the direction from which the RF signal is being received. In one embodiment, the display may further indicate the number of signals being received. In another embodiment, the display 460 is part of a device configured to communicate wirelessly with the apparatus 410.

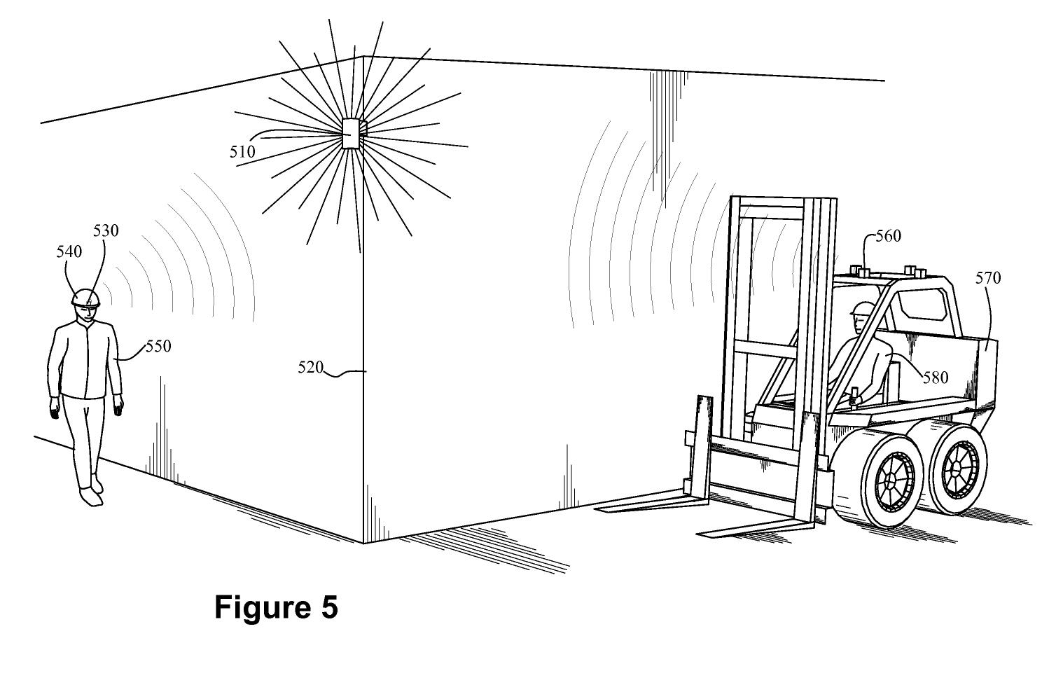

FIG. 5 illustrates an alternative embodiment of the apparatus for warning of a potential collision. In the illustrated embodiment, an intersection device 510 may be installed at an intersection 520. The intersection device 510 receives an RF signal from a hardhat device 530 attached to the hardhat 540 worn by the person 550. The intersection device 510 also receives an RF signal from a vehicle device 560 attached to the vehicle 570. The RF signal from the hardhat device 530 includes a device identifier identifying the hardhat device 530 as a device attached to a person. The RF signal from the vehicle device 560 includes a device identifier identifying the vehicle device 560 as a device attached to a vehicle.

The intersection device 510 is configured to determine signal strengths of the RF signals from the hardhat device 530 and from the vehicle device 560. The intersection device 510 is further configured to issue a warning signal based at least in part on the signal strength of the RF signal from the hardhat device 530 and the RF signal from the vehicle device 560.

In the illustrated embodiment, the intersection device 510 determines based on the signal strengths that both the person 550 and the vehicle 570 are approaching the intersection 520. The intersection device 510 flashes a light to warn the person 550 and the operator 580 of the vehicle 570 of the potential collision.

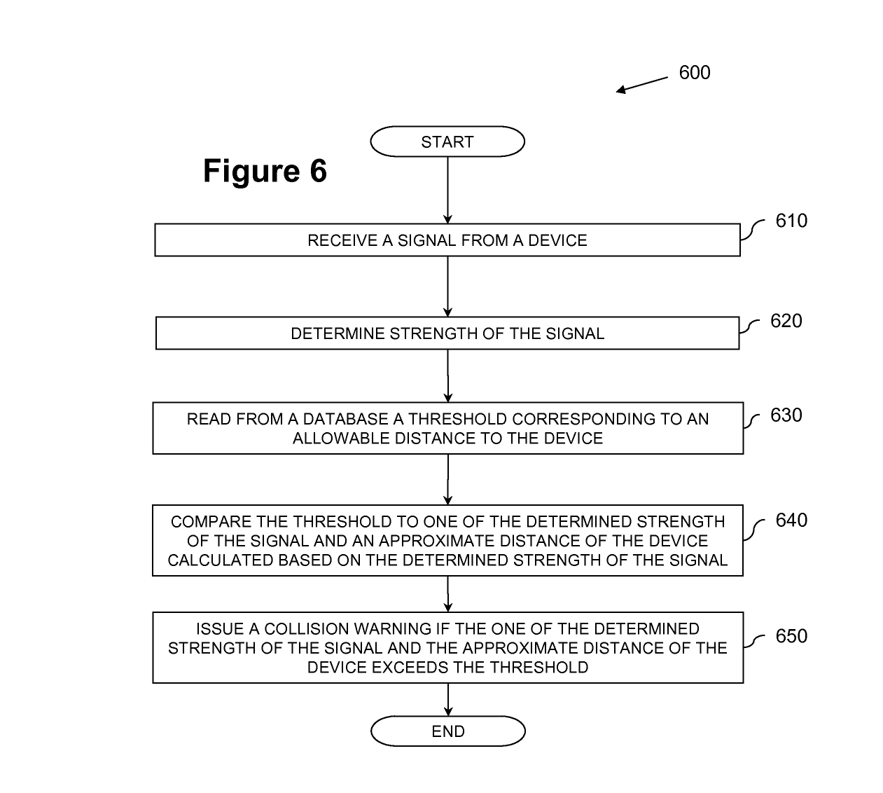

Example methods may be better appreciated with reference to the flow diagram of FIG. 6. While for purposes of simplicity of explanation, the illustrated methodologies are shown and described as a series of blocks, it is to be appreciated that the methodologies are not limited by the order of the blocks, as some blocks can occur in different orders or concurrently with other blocks from that shown and described. Moreover, less than all the illustrated blocks may be required to implement an example methodology. Furthermore, additional or alternative methodologies can employ additional, not illustrated blocks.

In the flow diagrams, blocks denote “processing blocks” that may be implemented with logic. The processing blocks may represent a method step or an apparatus element for performing the method step. A flow diagram does not depict syntax for any particular programming language, methodology, or style (e.g., procedural, object-oriented). Rather, a flow diagram illustrates functional information one skilled in the art may employ to develop logic to perform the illustrated processing.

It will be appreciated that in some examples, program elements like temporary variables, routine loops, and so on, are not shown. It will be further appreciated that electronic and software applications may involve dynamic and flexible processes so that the illustrated blocks can be performed in other sequences that are different from those shown or that blocks may be combined or separated into multiple components. It will be appreciated that the processes may be implemented using various programming approaches like machine language, procedural, object oriented or artificial intelligence techniques. In one example, methodologies are implemented as processor executable instructions or operations provided on a computer-readable medium.

While FIG. 6 illustrates various actions occurring in serial, it is to be appreciated that various actions illustrated in FIG. 6 could occur substantially in parallel. While a number of processes are described, it is to be appreciated that a greater or lesser number of processes could be employed and that lightweight processes, regular processes, threads, and other approaches could be employed. It is to be appreciated that other example methods may, in some cases, also include actions that occur substantially in parallel.

FIG. 6 illustrates a flow diagram of a method 600 for avoiding collisions. At 610, the method 600 includes receiving a signal from a device. The signal may include an identifier of the device transmitting the signal. At 620, the method 600 includes determining strength of the signal. At 630, the method 600 includes reading from a database a threshold corresponding to an allowable distance to the device. At 640, the method 600 includes comparing the threshold to one of the determined strength of the signal and an approximate distance of the device calculated based on the determined strength of the signal.

At 650, the method 600 includes issuing a collision warning if the one of the determined strength of the signal and the approximate distance of the device exceeds the threshold. The one of the determined strength of the signal and the approximate distance of the device may exceed the threshold by being lower than the threshold or by being higher than the threshold depending on the implementation. For example, if the threshold represents signal strength, the determined signal strength of the transmitting device would exceed the threshold by being higher than the threshold because the higher the strength of the signal, the closer the device would be. If on the other hand, the threshold represents physical distance, the approximate distance of the device calculated based on the signal strength would exceed the threshold by being lower than the threshold because the lower the distance, the closer the device would be.

While example systems, methods, and so on, have been illustrated by describing examples, and while the examples have been described in considerable detail, it is not the intention of the applicants to restrict or in any way limit the scope of the appended claims to such detail. It is, of course, not possible to describe every conceivable combination of components or methodologies for purposes of describing the systems, methods, and so on, described herein. Additional advantages and modifications will readily appear to those skilled in the art. Therefore, the invention is not limited to the specific details, the representative apparatus, and illustrative examples shown and described. Thus, this application is intended to embrace alterations, modifications, and variations that fall within the scope of the appended claims. Furthermore, the preceding description is not meant to limit the scope of the invention. Rather, the scope of the invention is to be determined by the appended claims and their equivalents.

To the extent that the term “includes” or “including” is employed in the detailed description or the claims, it is intended to be inclusive in a manner similar to the term “comprising” as that term is interpreted when employed as a transitional word in a claim. Furthermore, to the extent that the term “or” is employed in the detailed description or claims (e.g., A or B) it is intended to mean “A or B or both”. When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995).

What is claimed is:

1. A system for warning of potential collisions among a plurality of subjects, the system comprising:
a plurality of devices including at least:
a first device configured to be transported by a first subject, where the first device has a first device identifier, and where the first device includes:
a first transceiver configured to transmit a first radio frequency signal including the first device identifier,
at least one antenna operably connected to the first transceiver,
a first processor operably connected to the first transceiver, and
a first storage medium operably connected to the first processor; and
a second device configured to be transported by a second subject, where the second device has a second device identifier, and where the second device includes:
a second transceiver configured to transmit a second radio frequency signal including the second device identifier,
a second processor operably connected to the second transceiver, and
a second storage medium operably connected to the second processor;
where the first transceiver is configured to receive radio frequency signals including the second radio frequency signal, where the first processor is configured to store the second device identifier in the first storage medium, where the first processor is configured to determine a second signal strength of the received second radio frequency signal, and where the first processor is configured to issue a first warning signal based at least in part on at least one of the second signal strength and the second device identifier, where the first warning signal is configured to warn the first subject of a potential collision between the first subject and the second subject; and
where the second transceiver is configured to receive radio frequency signals including the first radio frequency signal, and where the second processor is configured to store the first device identifier in the second storage medium, where the second processor is configured to determine a first signal strength of the received first radio frequency signal.

2. The system of claim 1, where the second processor is further configured to issue a second warning signal based at least in part on at least one of the first signal strength and the first device identifier, and where the second warning signal is configured to warn the second subject of the potential collision between the first subject and the second subject.

3. The system of claim 2,
where the second device identifier is at least one of a second device ID and a second device type,
where the first processor is configured to issue the first warning signal based at least in part on the second signal strength and at least one of the second device ID and the second device type by comparing the second signal strength to a second preprogrammed threshold corresponding to the at least one of the second device ID and the second device type,
where the second preprogrammed threshold substantially corresponds to a first distance between the first device and the second device,
where the first device identifier is at least one of a first device ID and a first device type,
where the second processor is configured to issue the second warning signal based at least in part on the first signal strength and at least one of the first device ID and the first device type by comparing the first signal strength to a first preprogrammed threshold corresponding to at least one of the first device ID and the first device type, and
where the first preprogrammed threshold substantially corresponds to a second distance between the first device and the second device.

4. The system of claim 3, where the first preprogrammed threshold and the second preprogrammed threshold are programmable via a wireless link between a programming device and the corresponding device from the first device and the second device.

5. The system of claim 1, where the first subject and the second subject are selected from the group consisting of:
a person;
a hardhat;
a vehicle;
an intersection; and
a crane.

6. The system of claim 1, where the second device is a member of a group, and the first processor is configured to issue the first warning signal based at least in part on the second device membership in the group.

7. The system of claim 1, where the plurality of devices further comprises:
a third device configured to be transported by a third subject, where the third device has a third device identifier, and where the third device includes:
a third transceiver configured to transmit a third radio frequency signal including the third device identifier,
a third processor operably connected to the third transceiver, and
a third storage medium operably connected to the third processor;
where the third transceiver is configured to receive radio frequency signals including the first radio frequency signal and the second radio frequency signal,
where the third processor is configured to store the first device identifier and the second device identifier in the third storage medium,
where the third processor is configured to determine a third signal strength of the received first radio frequency signal,
where the third processor is configured to determine a fourth signal strength of the received second radio frequency signal,
where the third processor is configured to issue a third warning signal based at least in part on at least one of the third signal strength and the first device identifier, where the third signal strength substantially corresponds to a third distance between the first device and the third device; and
where the third processor is configured to issue a fourth warning signal based at least in part on at least one of the fourth signal strength and the second device identifier, where the third signal strength substantially corresponds to a fourth distance between the second device and the third device.

8. The system of claim 1, where the first transceiver is configured to transmit the first radio frequency signal at least one of several times per second and approximately 300 feet.

9. The system of claim 1, where the first warning signal manifests in a form selected from the group consisting of:
a light,
a flashing light,
a vibration, and
a sound.

10. The system of claim 1, where an antenna power setting of the at least one antenna is programmable.

11. The system of claim 1, where the first device further comprises:
at least two antennas operably connected to the first transceiver, where the at least two antennas are configured to attach to the first subject such that the second signal strength of the received second radio frequency signal has at least two components, one component for each of the at least two antennas, and where the first processor is configured to substantially determine the incoming direction of the received second radio frequency signal based at least in part on the at least two components.

12. The system of claim 1, where the first device further comprises:
at least four antennas operably connected to the first transceiver, where the at least four antennas are configured to attach to the first subject such that the second signal strength of the received second radio frequency signal has at least four components, one component for each of the at least four antennas, and where the first processor is configured to substantially determine the incoming direction of the received second radio frequency signal based at least in part on the at least four components.

13. The system of claim 1, where the first storage medium includes a first database configured to store historical data.

14. The system of claim 1, where the first processor is configured to determine the second signal strength by continuously sampling a signal strength indication of the second signal, calculating a running average of the signal strength indication and removing outliers samples of the signal strength indication.

15. The system of claim 1, where the second radio frequency signal further includes data representing a second radio profile describing characteristics of the second transceiver including radio broadcast power, antenna characteristics and transmission signal strength; and
where the first processor is configured to determine the first distance between the first device and the second device based at least in part on the second signal strength and the second radio profile.

16. An apparatus configured to warn of a potential collision between a first subject and a second subject, the apparatus comprising:
a transceiver;
a processor operably connected to the transceiver,
where the processor is configured to cause the transceiver to transmit an outgoing signal comprising a device identifier,
where the processor is further configured to receive from the transceiver incoming signals including
a first incoming signal transmitted by a first apparatus, where the first incoming signal comprises a first device identifier, and
a second incoming signal transmitted by a second apparatus, where the second incoming signal comprises a second device identifier,
where the processor is configured to determine a first signal strength of the first incoming signal;
where the processor is configured to determine a second signal strength of the second incoming signal;
where the processor is further configured to issue a warning signal based at least in part on at least one of:
(a) the first signal strength and the first device identifier,
(b) the second signal strength and the second device identifier, and
(c) the first signal strength, the first device identifier, the second signal strength and the second device identifier; and
where the processor is further configured to compare the first signal strength to a preprogrammed threshold and issue the warning signal based at least in part on whether the first signal strength exceeds the preprogrammed threshold.

17. The apparatus of claim 16, where the device identifier correlates to a set of preprogrammed threshold distances between the apparatus and other apparatuses, where the first device identifier correlates to a first set of preprogrammed threshold distances between the first apparatus and other apparatuses, and where the second device identifier correlates to a second set of preprogrammed threshold distances between the second apparatus and other apparatuses.
